(19) United States
(12) Patent Application Publication
(10) Pub. No.: US 2010/0060946 A1
(43) Pub. Date: Mar. 11, 2010

(54) Apparatus for electronic capture of business card data

(76) Inventor: Dana Bath, Highlands Ranch, CO (US)

Correspondence Address: David E. Orr, 4616 NE 134th Street, Vancouver, WA, 98686, US

(21) Appl. No.: 12/231,713

(22) Filed: Sep. 6, 2008

(51) Int. Cl. H04N 1/00

(52) U.S. Cl. 358/403

(57) ABSTRACT

The present invention offers a system and method for users to maintain, manage, manipulate, and transmit business card and other business and professional related data via automated means through a scanner that inputs initial data into a computing system, a computing system that allows for the organization and administration of that data, and a connection from that computing system to a web-based server that allows for the transmission and further manipulation of that data by a community of users linked to that server. The invention allows users not only to update business card and other related data remotely but to integrate, share, and reconfigure that data in a utilitarian manner. The invention includes a system and method for analyzing and correlating a database of business card data.

### FIELD

The present invention is an apparatus for capturing, storing and using business card data by electronic means, and includes a system and method for utilizing said data.

### BACKGROUND

Business cards represent a common means for individuals to distribute and acquire basic and essential information. This information serves as a starting point for business transactions and professional relationships between parties offering and seeking a wide array of goods and services. However, business cards, essentially small scraps of cardboard, are easily lost or destroyed, along with the information contained upon them. The efficacy of business cards is lessened further by the problems of storage and organization associated with the accumulation of a large number of business cards and the retrieval and manipulation of the data contained on these cards. Business cards also represent a waste of physical resources resulting from the production of and disposal of the physical cards.

A need, therefore, exists for an apparatus to efficiently capture and retain business cards and the information they contain. This apparatus will not only electronically preserve business card data by scanning and storing it electronically in a processing device but allow users to organize, extract, manipulate, transmit, receive, and share that data, increasing efficiency and decreasing waste of time and resources.

Of particular interest is an apparatus that will permit users to utilize business card data in novel and unobvious ways. The apparatus would provide a means for automated revision to and updating of the data. The apparatus would provide a means for the proposal of business and professional opportunities by those in need of goods or services as well as the submission of offers and bids by providers to supply those goods or services. The apparatus would allow users to synergistically connect various providers or demanders of goods and services through cross referencing patterns. And the apparatus would allow users to rank, evaluate, and share information about providers and demanders of goods and services. In this manner, an apparatus for the capture and utilization of business card data could increase the efficiency and effectiveness of business and professional services and relationships.

### OBJECTS

Therefore, in recognition of the benefits and utility of an apparatus for capturing, storing and using data found on business cards, herein is disclosed, in two aspects, a system and method for capturing, storing, transmitting and using data from ordinary business cards. The system and method of the invention has advantages and benefits over the prior art, the first benefit being an apparatus that may be deployed in a variety of configurations.

In a first configuration, the object and benefits include an apparatus that provides a means and system for the capture, storing, management, and utilization of data electronically, precluding the disadvantages of data loss and wasted time and resources associated with the prior art of traditional business cards and the management and application of their data.

A second object and benefit of this first configuration involves an apparatus that enables the ability of both the furnisher and the obtainer of the business card and its concomitant data to update, synchronize, and exchange information related to the initial data in an automated manner through remote devices and databases, providing an advantage over the stagnant nature of traditional business cards.

In a second configuration, a system and method is provided with advantages and benefits to the prior art of business card scanners through an apparatus such as a USB device and other remote and portable databases and processors that allow for synchronization and cross communication between multiple users of the business card scanning apparatus, linking both seekers and providers of goods and services within specified locations such as a shopping mall, office building, or business district.

One object and benefit of this second configuration involves the ability through the apparatus to simultaneously contact multiple, on-site providers of similar goods or services whose data has been collected in a specified location, for example, a shopping mall, an office building, or business district, with offers or proposals for business, such as a consumer seeking to buy shoes, and for the suppliers of these goods or services, such as shoe store salespeople, to reply instantaneously in a bid-like fashion to these seekers of goods and services, thus providing an advantage over the previous art of business card scanners that linked only individual furnishers and obtainers of business cards and their data at remote distances.

A second object and benefit of this second configuration involves the ability to synergistically connect divergent providers of goods and services to seekers of goods and services with complex and multifaceted needs, enabling, for example, a home improvement consumer on-site at a location such as a shopping mall or business district or remotely, to exchange data collectively with a decorator, a painter, and a provider of home furnishings, thus providing advantages over the previous art of business card scanners that linked only individual furnishers and obtainers of business cards and their data at remote distances.

A third object and benefit of this second configuration involves the enabling of procurers of goods and services to supply data describing, evaluating, and ranking the providers of these goods and services and their providers within a specific location such as a shopping mall, an office building, or a business district, allowing seekers of goods and services an on-site or remote means of obtaining this information in order to make informed decisions about their needs and potential purchases, thus providing an advantage over the previous art of business card scanners that failed to allow for broad-based and even public targeted access to their data.

Other benefits and advantages of the invention will appear from the disclosure to follow. In the disclosure reference is made to the accompanying drawings, which form a part hereof and in which is shown by way of illustration specific embodiments in which the invention may be practiced. These embodiments will be described in sufficient detail to enable those skilled in the art to practice the invention, and it is to be understood that other embodiments may be utilized and that structural changes may be made in details of the embodiments without departing from the scope of the invention.

### SUMMARY

In a first aspect the invention is disclosed as an apparatus comprising a scanner, a processing element having storage, display, and input means, such as a keyboard and mouse. The first aspect is furnished with software to facilitate the process of capturing, storing, displaying, and manipulating data obtained from a business card. In the first aspect, the invention may be used in an office, where persons present business cards. Cards are scanned, data is stored, and later manipulated and used, reducing or eliminating the need for retention and organization of printed business cards.

In the first aspect, additional data or information may be added to captured data and stored with captured data. For example, additional data may include personal information about the business card owner, or may include the nature of the event in which the business card was presented for capture.

In a second aspect, the invention comprises a scanning device, and an interface device for transmitting and receiving digital information, such as a communications or USB interface. The second aspect further includes an Internet connection, and a server for receiving and storing data captured from a business card. The second aspect includes software for scanning and capturing business card data, and also includes server software for storing, retrieving, and sharing business card data as well as data from subsequent interactions between the aforementioned providers and receivers of business cards. In the second aspect, the invention is used in a business service, such as would be found at a shopping mall, office building, or business district where business card data is captured and stored on a server. The data may also be stored on a USB drive, which may belong to the owner of the business card.

Through this second aspect of the invention, the automated, electronic updating of business card data occurs, precluding the need to revise, reprint, redistribute, receive, reorganize, and restore business cards. This second aspect of the invention also allows for manipulation of business card data and subsequent data from the relationships the business cards engender in novel and utilitarian ways to produce a more effective exchange of goods and services. By facilitating processes wherein obtainers of business cards can gather and compare on-site or remotely information from purveyors of similar goods and services, can interact on-site or remotely with purveyors of differing though synergistically connected goods and services, and provide feedback on the suppliers of goods and services for other seekers of goods and services, the invention herein disclosed makes possible tangibly more efficient and productive business and professional relationships.

Further, in the second aspect, business card data with possible annotations are captured on a server, and by server hardware and software means, captured data may be compared, or correlated with other data, and by such comparison or correlation, an owner of a business cards may be associated with or linked to other owners of business cards. The correlation or comparison may also result in the owner of the business card receiving messages, through which offers of goods or services may be made.

### BRIEF DESCRIPTION OF THE DRAWINGS

FIG. 1 illustrates a first aspect of the invention comprising an apparatus for capturing and manipulating business card data in an office environment.

FIG. 2 illustrates a second aspect of the invention comprising an apparatus for capturing business card data and communicating said data with a server over a communications link.

FIG. 3 illustrates logic by which a business card owner's data is associated with data stored on a server capturing the owner's business card data.

### DETAILED DESCRIPTION

### Exemplary Embodiments of a First Aspect and a Second Aspect of the Invention

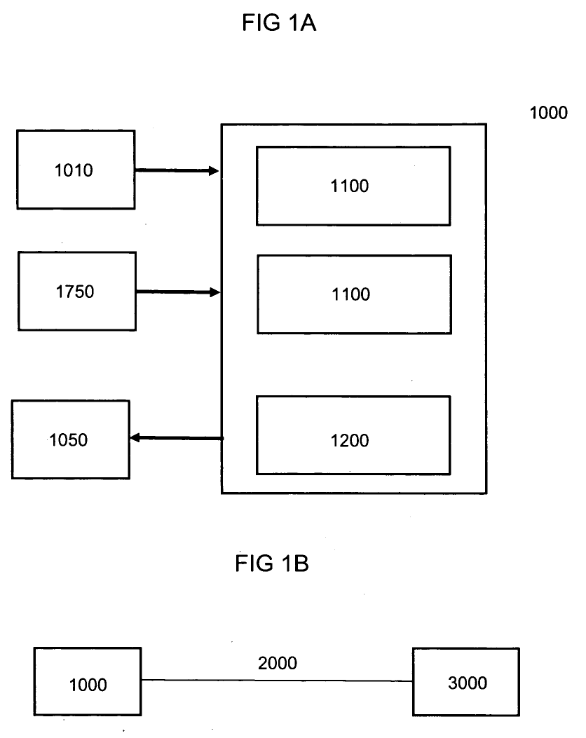

FIG. 1A and FIG. 1B illustrate a first aspect and a second aspect of the present invention.

In FIG. 1A, illustrating a first aspect of the present invention, the apparatus of the invention 1000 comprises a computing environment with a processing unit 1100 and a storage component 1200. The computing environment 1000 possesses additional features including one or more mechanisms of input accessibility to enable devices such as a scanner 1010 or other source of data, and one or more means of output accessibility to enable devices such as a display monitor (1050) or other means of sharing data.

In FIG. 1B, illustrating a second aspect of the present invention, the apparatus of the invention 1000 comprises a computing environment with processing and storage capabilities is linked to a server 3000 through traditional means such as a wireless or wired Internet connection (not shown), allowing communications and data flow 2000 between the invention 1000 and the server 3000, which in turn can be accessed by other users.

### Computing Environment for the First and Second Aspects of the Invention

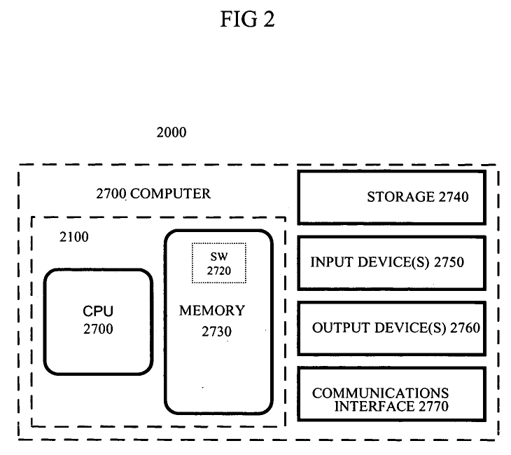

With reference to FIG. 2, the first and second aspects of the invention may be implemented, for example, within a computing environment 2000, which includes at least one processing unit 2700 and memory 2730. In FIG. 2, this most basic configuration 2000 is included within a dashed line. The processing unit 2700 executes computer-executable instructions and may be a real or a virtual processor. In a multi-processing system, multiple processing units execute computer-executable instructions to increase processing power. The memory 2730 may be volatile memory (e.g., registers, cache, RAM), non-volatile memory (e.g., ROM, EEPROM, flash memory, etc.), or some combination of the two. The memory 2730 stores executable software—instructions and data 2250—written and operative to execute and implement the software applications required for an interactive environment supporting practice of the invention.

The computing environment may have additional features. For example, the computing environment 2000 includes storage 2740, one or more input devices 2750, one or more output devices 2760, and one or more communication connections or interfaces 2770. An interconnection mechanism (not shown) such as a bus, controller, or network interconnects the components of the computing environment to the Internet, where the agent may be serialized and transmitted from server to server. Typically, operating system software (not shown) provides an operating environment for other software executing in the computing environment, and coordinates activities of the components of the computing environment.

The storage 2740 may be removable or non-removable, and includes magnetic disks, CD-ROMs, DVDs, or any other medium which can be used to store information and which can be accessed within the computing environment. For example, the storage may store business card data derived from scanning and processing business cards. The storage 2740 also stores instructions for the software 2720, such as software for operating systems and connections and interactions with web servers.

The input device(s) 2750 may be a touch input device such as a keyboard, mouse, pen, or trackball, a voice input device, a scanning device, or another device that provides input to the computing environment. For audio or video, the input device(s) may be a sound card, video card, TV tuner card, or similar device that accepts audio or video input in analog or digital form. The output device(s) 2760 may be a display, printer, speaker, or another device that provides output from the computing environment.

The communication interface 2770 enable the operating system and software applications to exchange messages over a communication medium with the scanning device, display and editing of business card data in various instantiations of aspects of the invention. The communication medium conveys information such as computer-executable instructions, business card data and data in a modulated data signal. A modulated data signal is a signal that has one or more of its characteristics set or changed in such a manner as to encode information in the signal. By way of example, and not limitation, the communication media include wired or wireless techniques implemented with an electrical, optical, RF, infrared, acoustic, or other carrier.

The communications interface 2770 is used to communicate with other devices and computers. For example, the interface 2770 may be attached to a network, such as the Internet, whereby the computing environment 2000 interchanges command, control and feedback signals with other computers, devices, and machinery.

### A First Aspect of the Invention

In a first aspect of the invention, a system and method are described for capturing, storing, manipulating, and managing business cards and the data contained thereon. This aspect of the invention and the method and system described are not limited to the utilization of business card data but may be similarly applied to other forms of data.

In this first aspect of the invention and in reference to FIG. 1A, a scanner 1010 is used to scan a business card, collecting its data. The scanner 1010 is connected to the apparatus of the invention, a computing environment 1000, through a USB or other known, standard interfaces. Through this connection, the scanned business card data enter the computing environment 1000 where the computing environment's processor 1100 and storage 1200 components in conjunction with personal information management software (not shown), such as MS Word, PowerPoint, SQL Server, Access, Outlook, ACT!, Maximizer, and Goldmine will maintain, organize, manipulate, and utilize the scanned data. The computing apparatus 1000 also possesses one or more means for output or display 1050 such as a connection to a USB device or monitor that will allow for the sharing and transmission of the scanned and managed business card data.

Through other input devices 1750, additional data, such as annotations made by a user is entered through the processor 1 100 and into storage. Data (captured or entered) may be stored locally or may be sent to a server connected to the processor 1 100.

### A Second Aspect of the Invention

In a second aspect of the invention, a system and method are described for the manipulation, integration, and transmission of business cards and the data contained thereon. This aspect of the invention and the method and system described are not limited to the utilization of business card data but may be similarly applied to other forms of data.

In this second aspect of the invention and in reference to FIG. 1B, the apparatus of the invention 1000, a computing device with processing and storage capabilities, has been uploaded with scanned business cards and the data contained thereon. These data have been managed and manipulated using appropriate software. The computing device 1000 possesses one of more means for output or display to a server 3000 through which data are transmitted via a network such as a wireless or wired Internet connection 2000. A multiplicity of individuals is connected to this data transmission system 2000 via the server 3000 and their individual computing apparatuses 1000.

Via this data transmission network 2000, obtainers of business card data and distributors of business card data share, manage, and manipulate data in their respective computing environments 1000, including but not limited to the automated updating of business card data, requests to singular or multiple remote computing environments connected to the server 3000 for data, distribution of data to singular or multiple remote computing environments connected to the server 3000, and communal sharing of data among some or all computing environments connected to the server.

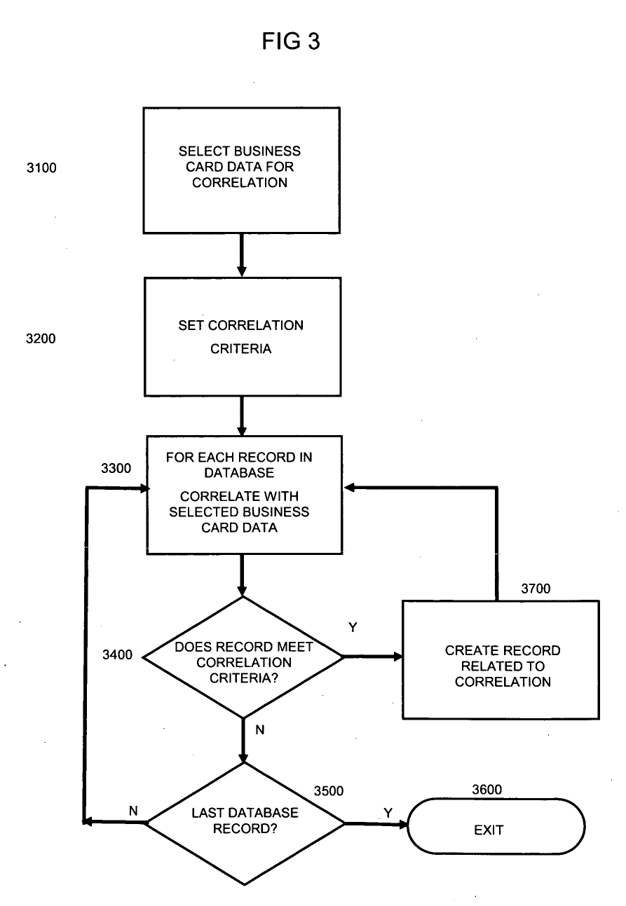

FIG. 3 illustrates a system and method associated with the invention. This system and method is used to correlate data captured from one business card with data captured from a plurality of other business cards. Business card data that has a high degree of correlation with a business card is processed into a message, which is either stored on the server or sent elsewhere. Applications of this system and method include the following:
1. Identification of business cards related to similar products or services associated with a given business card.
2. Identification of business cards related to complementary products or services associated with a given business card.
3. Association of business cards in a certain geographic area. For example, the application may be to set up a network of related business products or services within a geographic area, such as a zip code address on business cards.

In FIG. 3, a business card is selected 3100 for correlation. Selection may involve selection of a business card by computer system query, and selecting data from the selected business card for correlation.

Once a business card is selected, correlation criteria is established 3200. Criteria include data fields on the card that are to be correlated and degree of match (by correlation) for other business card data stored.

In FIG. 3, the system and method processes a loop 3300, 3400, 3500 and 3700, wherein each stored record (comprising business card data) is analyzed and correlated according to the correlation criteria set in step 3200.

If a stored record meets the correlation criteria in 3400, a second record is created in step 3700. This second record comprises data derived from the correlation (such as matched data, or other data field in the matched record.) This second record is stored and may be retrieved or sent elsewhere.

The processing loop 3300 through 3700 is maintained until all records are correlated according to the correlation criteria. When all records are processed, the method terminates 3600.

What is claimed is:

1. A networked computer method for processing business cards, the method comprising:
providing a first server attached to the network, the first server having storage means for storing data extracted from business card, the first server further including software for correlating data stored on the server, and;
providing a scanner, the scanner in communication with the first server, the scanner for capturing data from business cards;
whereby data captured from a specific business card may be correlated with data stored on the first server.

2. The method of claim 1, wherein the correlation comprises associating a name on the specific business card with an event.

3. The method of claim 1, wherein the first server further has software for accepting input data associated with the specific business card.

4. The method of claim 1, the method further including:
providing a second server in communication with the first server;
providing software in the first server for sending business card data to the second server;
providing software in the second server for receiving business card data sent by the first server, and;
providing software means in the second server for displaying and printing business card data received from the first server.
